(19) United States
(12) Patent Application Publication
(10) Pub. No.: US 2007/0179000 A1
(43) Pub. Date: Aug. 2, 2007

(54) Device for transmitting torque

(76) Inventors: Daniel Damson, Weissach (DE); Matthias Jaeger, Madrid (ES); Angel Luis Castillo Redondo, Aranjuez (ES); Horst Callies, Nagold (DE); Alfonso Martinez Lesma, Aranjuez (ES)

Correspondence Address: Striker Striker & Stenby, 103 East Neck Road, Huntington, NY, 11743, US

(21) Appl. No.: 10/587,673

(22) PCT Filed: Jul. 29, 2005
(86) PCT No.: PCT/EP05/53710

§ 371 Date: Jul. 27, 2006

(30) Foreign Application Priority Data
Jul. 30, 2004 (DE) 10 2004 038 420.7

(51) Int. Cl. F16H 55/36; F16H 55/06; F16D 3/00

(52) U.S. Cl. 474/94; 474/902; 474/161; 74/411

(57) ABSTRACT

The present invention relates to a device (2) for transmitting torque from a pulley (6) to a hub (10) of an assembly to be driven, in particular a compressor (4), e.g., an air conditioning compressor of a motor vehicle, with a vibration-damping element (12) located between the pulley (6) and the hub (10).

It is provided that the vibration-damping element (12) is rigidly connected at its inner circumference with the hub (10) and is engaged at its outer circumference with the pulley (6).

The present invention relates to a device according to the definition of the species in claim 1.

### BACKGROUND INFORMATION

Newer air conditioning compressors for motor vehicles or other mobile applications typically include a pulley that is driven by an internal combustion engine via a belt drive. The torque applied by the belt drive to the belt pulley is transmitted by the pulley mostly to a hub that is non-rotatably connected with the compressor shaft of the air conditioning compressor. A vibration-damping element located between the pulley and the hub serves to dampen vibrations from the crankshaft of the internal combustion engine or the belt drive, and vibrations resulting from changing loads on the air conditioning compressor. An overload safeguard is typically also located in the torque transmission path between the pulley and the compressor shaft that irreversibly interrupts the transmission if an overload occurs.

A device of the type mentioned initially is known, e.g., from DE 198 60 150 A1. The known device is part of the drive train of an air conditioning compressor of a motor vehicle in which a driving disk that is rotatably connected with the hub is located between the ribbed, plastic pulley that is driven by the internal combustion engine of the motor vehicle using a belt drive and the metallic hub fastened to a compressor shaft of the air conditioning compressor, the driving disk having a large number of drivers located such that they are spaced apart in the circumferential direction. Trapezoidal elastomer elements are located between the drivers on the driving pulley and adjacent ribs on the pulley that serve to transmit torque from the pulley to the hub and to dampen vibrations, and that can form a single ring element. At high rotary speeds, however, the centrifugal forces produced can cause the elastomer elements to become deformed, resulting in air gaps forming between them and the ribs or drivers. Noise is produced as a result when the torque fluctuates. The relatively large number of components in the known torque transmission device is also considered to be disadvantageous.

### Advantages of the Invention

In contrast, the device according to the present invention with the features mentioned in claim 1 offers the advantage—particularly when a pulley is used that is made of a moldable material—that the limitless shaping options of the materials used to make the vibration-damping element and the pulley can be better used to enable play-free transmission of torque between the pulley and the hub and to reduce the number of components required, since the moldability of the vibration-damping element and the pulley makes it possible to realize a form-fit and, optionally, detachable connection between these two components in a relatively easy manner and without the need for additional components. In addition, the overall axial length of the compressor and the device can be shortened by connecting the hub or pulley to the inner or outer circumference of the vibration-damping element.

A preferred embodiment of the present invention provides that the vibration-damping element is composed of an elastomer material and, given that it is vulcanized to the hub, it is attached in a non-rotatable, integral manner thereto, by way of which the two components form a single component, and a direct power flow is established between the vibration-damping element and the hub.

According to a further, particularly preferred embodiment of the present invention, the essentially annular vibration-damping element has outer toothing that, after the device is assembled, meshes with inner toothing on the pulley and joins the two components in a form-fit manner. To simplify the assembly of the device, assembly is advantageously carried out using an axial relative motion between the hub with the vibration-damping element and the pulley, the vibration-damping element being brought into engagement with the pulley in a form-fit manner. The connection can be designed to be detachable or non-detachable, e.g., by bonding the two components together.

To prevent air gaps from forming between the two tooth systems during operation as a result of different thermal expansion of the materials in the vibration-damping element and the pulley—which air gaps would cause noise to be produced when the torque changes—the teeth in the inner tooth system of the pulley and the teeth in the outer tooth system of the vibration-damping element advantageously have tooth flanks that bear against each other without play.

According to a further advantageous embodiment of the present invention, the height of teeth in the inner toothing of the pulley is greater in every operating state than the height of teeth in the outer toothing of the vibration-damping element, to allow unrestricted thermal expansion of their teeth despite the different thermal expansion coefficients.

Since the material used to make the pulley is stronger, a further advantageous embodiment of the present invention provides that its teeth are much narrower at the tooth root than the teeth of the vibration-damping element, so that the teeth have comparable resistances to deformation and the deformation of the vibration-damping element is essentially limited to a region between its inner circumferential surface vulcanized to the hub and the root of the teeth, while an undesired deformation and energy absorption in the region of the teeth itself is prevented. To allow unrestricted deformation of the vibration-damping element in the region between its inner circumferential surface and the root of the teeth, a compressor-side end face of the vibration-damping element is also located in this region, advantageously at a sufficient axial distance from axially adjacent parts of the pulley or the compressor.

The overload safeguard of the torque-transmission device according to the present invention, which serves to limit torque, is advantageously integrated in the hub, which is preferably provided with an intended breaking point for this purpose.

### DRAWING

The present invention is explained below in greater detail in an exemplary embodiment, with reference to the attached drawing.

FIG. 1 shows a perspective view of a torque-transmission device according to the present invention;

FIG. 2 shows a partially exposed, perspective view of the torque-transmission device in the installed state on an air conditioning compressor of a motor vehicle;

FIG. 3 shows a top view of part of the torque-transmission device;

FIG. 4 shows a partially exposed view of a damping element of the torque-transmission device.

The exemplary embodiment of a device 2 for transmitting torque shown in the drawing is part of a drive of an air conditioning compressor 4 of a motor vehicle and includes a pulley 6 driven by an internal combustion engine (not shown) of the motor vehicle via a belt drive (not shown), a hub 10 capable of being non-rotatably connected with a compressor shaft 8 of the air conditioning compressor 4, and an essentially annular vibration-damping element 12 that is located between pulley 6 and hub 10 and is non-rotatably connected with hub 10, vibration-damping element 12 serving to transmit torque from pulley 6 to hub 10 and to simultaneously dampen vibrations.

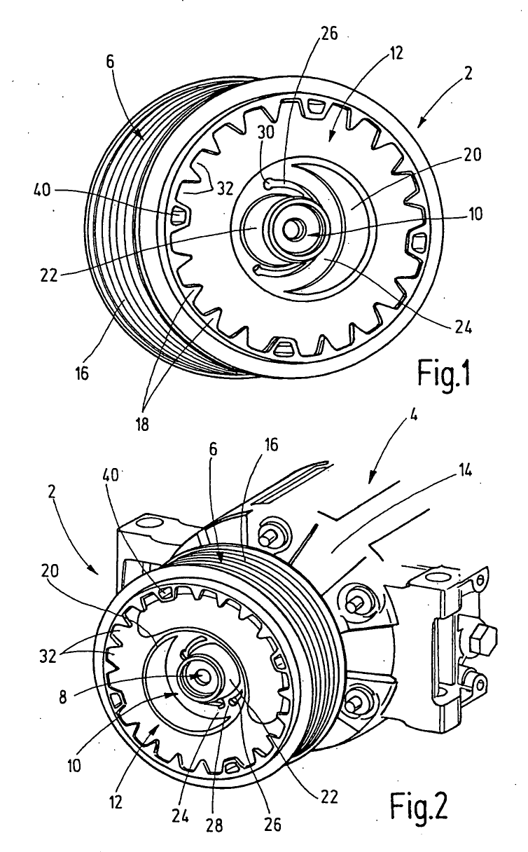

The vibration-damping element, which is located between pulley 6 and hub 10, is not limited to an annular design as shown in FIGS. 1 and 2. Instead, it could also have a radial configuration or another type of configuration. In addition, the described and claimed device for transmitting torque is not limited to the use of only one vibration-damping element of this type.

The multigroove V-belt sheave 6, which is made of thermoplastic material via injection-moulding and is rotatably mounted using a bearing (not shown) on a housing 14 of air conditioning compressor 4 includes, on its outer circumference, a plurality of grooves 16 with V-shaped cross-sections, located next to each other and extending in the axial direction. Pulley 6 is provided with inner toothing on its inner circumference, the inner toothing being composed of a plurality of radially inwardly directed teeth 18 integrally moulded on pulley 6. With device 2 shown, the tooth system includes a total of twenty teeth 18, four of which are wider and are located at angular distances of 90 degrees, while the remaining sixteen teeth are narrower and are located in groups of four next to each other at identical angular distances between two adjacent, wider teeth 18.

Hub 10, which is advantageously made of steel and preferably a carbon steel, is composed essentially of a hollow-cylindrical outer hub part 20—on the outer circumferential surface of which vibration-damping element 12 is rigidly fastened—a socket-shaped, inner hub part 22 that is capable of being inserted onto projecting compressor shaft 8 and is connectable in a non-rotatable, axially displaceable manner with compressor shaft 8, and a radial connecting part 24 located between inner hub part 22 and outer hub part 20, connecting part 24 defining an overload safeguard, to which end connecting part 24 includes a plurality of recesses 26 that extend essentially in the circumferential direction. Recesses 26 are separated by segments 28 in the circumferential direction that break if overloaded and therefore define the intended breaking points of hub 10. To prevent stress peaks, the end faces of recesses 26 are provided with rounded extensions 30.

The present invention is not limited to this type of overload safeguard, however. Further overload mechanisms are also possible.

Advantageously, a shaft-hub connection in the form of a conical seat connection can also be used. With these connections, a certain amount of inaccuracy in terms of the axial position of the parts cannot be ruled out, due to the nature of the system, since the tolerances cannot be kept infinitely small. With the proposed device for transmitting torque, the axial position of the damping element in the plastic part of the pulley can also vary. For this reason, the proposed shaft-hub connection in the form of a conical seat connection fits well with the axial position tolerances of the overall design. A system of this type therefore has a large tolerance in terms of the axial position between the shaft and hub.

Vibration-damping element 12, which is made of a vulcanizable elastomer material includes a cylindrical inner circumferential surface that, in the exemplary embodiment, is vulcanized to the cylindrical circumferential surface of hub part 20 and, in this manner, is integrally joined with hub 10 so that torque introduced by pulley 6 into vibration-damping element 12 is transmitted via this connection to hub 10 and, from there, to compressor shaft 8. To transmit torque from pulley 6 to vibration-damping element 12, the latter is provided with integral outer toothing on its outer circumference that is designed to complement the inner toothing of pulley 6, i.e., it has a total of twenty teeth 32 that are separated accordingly from teeth 18 of the inner toothing of pulley 6 by sixteen narrower or four wider tooth gaps. Teeth 18 and 32 of both toothings can be of a constant thickness in the axial direction between each particular root and its particular crown, or they can taper slightly in the direction of their crowns.

During assembly, the inner toothing of pulley 6 and the outer toothing of damping element 12 are brought into form-fit engagement via an axial relative motion. The connection between pulley 6 and damping element 12 can be specifically designed to be releasable or non-releasable.

This form-fit connection between the outer toothing of vibration-damping element 12 and the inner toothing of pulley 6—which can be releasable—is designed such that the particular diametrically opposed tooth flanks 34 of teeth 18 or 32 of the two tooth systems bear against each other without play in any operating state, so that, despite different thermal expansion coefficients of the elastomer material of vibration-damping element 12 and the plastic material of pulley 6 during operation of air conditioning compressor 4 across the entire temperature range, an air gap cannot form between adjacent teeth 18 or 32 in the tooth systems and, therefore, noise cannot be produced.

In addition to the teaching described, in which vibration-damping element 12 is vulcanized to inner hub 10 and the connection with the outer plastic material of pulley 6 is achieved in a form-fit manner, the fixed connection could also be provided on the outer edge of vibration-damping element 12. This fixed connection between vibration-damping element 12 and pulley 6 can also be established via vulcanizing, for example. In this case, a releasable or non-releasable form fit would be used on the inside, i.e., when connecting vibration-damping element 12 with hub 10, to transmit torque. Any type of form fit can be used.

Due to the different thermal expansion coefficients of the elastomer material of vibration-damping element 12 and the plastic material of pulley 6, the teeth height of both toothings is designed such that the height of teeth 32 of the outer toothing of vibration-damping element 12 is not greater than that of teeth 18 of the inner toothing of pulley 6 in any operating state. In general, the height of teeth 18 or 32 of both toothings can be dependent on the torque to be transmitted and the strength properties of the plastic or elastomer material used. Since the latter is not as strong as the former, the width of teeth 32 of the outer toothing of vibration-damping element 12 at the root is clearly greater than the width of teeth 18 of the inner toothing of pulley 6.

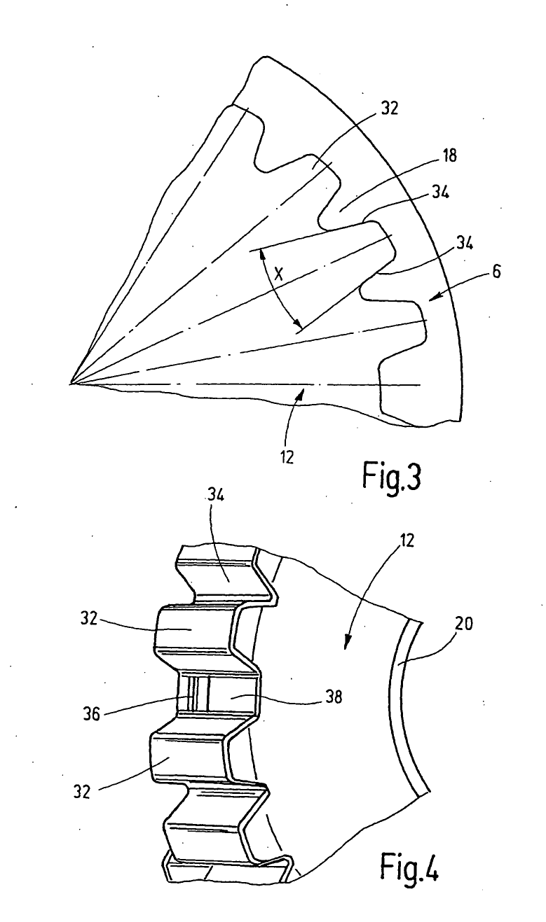

A tooth geometry is preferred for teeth 18, 32 with which angle X formed by diametrically opposed tooth flanks 34 of teeth 18, 32 is approximately 30 degrees, as best illustrated in FIG. 3. Any other acute angle X between 0 and 90 degrees can be selected, however.

The damping function of vibration-damping element 12 is based on a shear stress of the elastomer material in the region between its outer toothing and its inner circumferential surface connected with hub 10, this shear stress being induced when a static or dynamic torsion force occurs between pulley 6 and hub 10 in this region; it results in a material deformation there, while teeth 32 of vibration-damping element 12 remain largely undeformed and do not perform a damping function. In the region of its deformation between the outer toothing and the inner circumferential surface, vibration-damping element 12 of the exemplary embodiment preferably has a thickness that remains constant in the axial direction and is located—with its compressor-side end face, which is not shown in the drawing—at a certain axial distance from axially adjacent parts of pulley 6 or air conditioning compressor 4, so that vibration-damping element 12 can change shape freely in this region.

It can be advantageous to increase the thickness of damping element 12 in its inner region, i.e., in the region near the hub, to attain a constant material cross-sectional area. If the material thickness is not increased in the inner region of the damping element, the damping element therefore has, e.g., two parallel, flat limiting surfaces, so a damping element of this type does not behave in a linear manner. This results in an increase in deformation, in particular in the inner region near the hub of the damping element, which can result in impaired function of the device for transmitting torque.

To fix the outer toothing of vibration-damping element 12 in the axial direction relative to the inner toothing of pulley 6, to prevent the elastomer material from traveling outward due to centrifugal forces or due to deformation resulting from the shear stress, or to fix vibration-damping element 12 in place relative to pulley 6 if the overload safeguard in connecting part 24 of hub 10 should break, with device 2 shown in the drawing, vibration-damping element 12 is provided with a retaining element formed in the elastomer material in each of the regions of the four wider tooth gaps in its outer toothing, the retaining element being provided in the form of a ridge 36 projecting radially above base 38 of tooth gap and extending in the circumferential direction, ridge 36 engaging in a complementary recess (not shown) in the peak of one of the four wider teeth 18 of the inner toothing of pulley 6 after elastic compression setting during installation. Each of these latter teeth 18 has an axial opening 40 that leads into the end face of pulley 6 facing away from compressor 4 and makes it possible to carry out a visual inspection of ridge 36 to ensure it is seated correctly in the recess and, if necessary, to release the connection between retaining elements 36 and pulley 6.

In addition, the form-fit element between the damping element and the pulley can also be completely symmetrical. Since the damping element is inserted in the pulley with preload, the damping element is held in its position even if the overload safeguard should break, due to its overriding frictional connection.

The present invention is not limited to the use with a compressor, in particular an air conditioning compressor.

What is claimed is:

1. A device for transmitting torque from a pulley to a hub of an assembly to be driven, in particular an air conditionining compressor of a motor vehicle, with at least one vibration-damping element located between the pulley and the hub, wherein
the vibration-damping element (12) is rigidly connected at its inner circumference with the hub (10) and is engaged at its outer circumference with the pulley (6).

2. The device as recited in claim 1, wherein
the vibration-damping element (12) is composed of an elastomer material.

3. The device as recited in claim 2, wherein
the vibration-damping element (12) is vulcanized to the hub (10).

4. The device as recited in claim 2, wherein,
during assembly, it is possible to engage the hub (10), with the vibration-damping element (12), and the pulley (6) using an axial relative motion.

5. The device as recited in claim 2, wherein
the vibration-damping element (12) is detachably engaged with the pulley (6).

6. The device as recited in claim 1, wherein
the pulley (6) is composed of a plastic material.

7. The device as recited in claim 1, wherein
the vibration-damping element (12) is designed essentially annular in shape.

8. The device as recited in claim 1, wherein
the vibration-damping element (12) has an outer toothing that is engaged with an inner toothing on the pulley (6).

9. The device as recited in claim 8, wherein
the teeth (18) of the inner toothing of the pulley (6) and the teeth (32) of the outer toothing of the vibration-damping element (12) have tooth flanks (34) that bear against each other without play.

10. The device as recited in claim 8, wherein
diametrically opposed tooth flanks (34) of adjacent teeth (18) in the inner toothing of the pulley (6) and opposed tooth flanks (34) of teeth (32) in the outer toothing of the vibration-damping element (12) form an angle that is less than 90 degrees and is preferably approximately 30 degrees.

11. The device as recited in claim 8, wherein
a tooth height of teeth (18) of the inner toothing of the pulley (6) is greater in every operating state than the tooth height of teeth (32) of the outer toothing of the vibration-damping element (12).

12. The device as recited in claim 8, wherein
a tooth width of teeth (18) of the inner toothing of the pulley (6) is less than a tooth width of teeth (32) of the outer toothing of the vibration-damping element (12).

13. The device as recited in claim 8, wherein
the vibration-damping element (12) is located in the region between the hub (10) and the form-fit engagement with the pulley (6) at an axial distance from axially adjacent parts of the pulley (6).

14. The device as recited in claim 1, wherein
the hub (10) includes an overload safeguard (26, 28).
